(19) United States
(12) Patent Application Publication
(10) Pub. No.: US 2024/0002256 A1
(43) Pub. Date: Jan. 4, 2024

(54) PLANT AND PROCESS FOR THE TREATMENT OF MEDICINAL WASTE

(71) Applicant: NEWSTER SYSTEM S.R.L., Cerasolo di Coriano (RN) (IT)

(72) Inventors: Gianluca MAGRINI, Riccione (RN) (IT); Laura TREVISSON, Rimini (RN) (IT); Benedetta COPERTARO, Recanati (MC) (IT); Enrico CATAPANO, Rimini (RN) (IT); Marco PERICOLI, Rimini (RN) (US); Giorgio CASALBONI, Rimini (RN) (IT)

(21) Appl. No.: 18/253,639

(22) PCT Filed: Dec. 7, 2021
(86) PCT No.: PCT/IT2021/050394

§ 371 Date: May 19, 2023

(30) Foreign Application Priority Data
Dec. 9, 2020 (IT) 102020000030158

(51) Int. Cl. C02F 1/02

(52) U.S. Cl. CPC C02F 1/02; C02F 2103/003

(57) ABSTRACT

A plant for the treatment of medicinal waste including at least one reaction cell suitable for containing at least one liquid or liquid-diluted medicinal waste material; a heating system suitable for uniformly heating at least one portion of the outer surface of the reaction cell; and one device for controlling the pressure and temperature of the reaction cell, connected to the heating system.

### TECHNICAL FIELD

The present invention relates to a plant and a process for the treatment of medicinal waste.

### BACKGROUND ART

Over the past 20 years, the hospital waste disposal market has been made subject to international standards to avoid exposing healthcare workers, waste managers and the community as a whole to the risk of infection, toxic effects and injury. Indeed, it is now accepted that drug-resistant microorganisms can spread in the environment due to the constant presence of active pharmaceutical ingredients in water and soil.

In terms of medical waste management more generally, the Stockholm Convention on Persistent Organic Pollutants (POPs) aims to eliminate or limit their production. These chemicals are produced and consequently released into the environment by waste incineration and other waste burning processes.

In some countries, the adoption of the Convention has led to the closure of all small and medium-scale medical waste incinerators unable to comply with the maximum permissible concentration limits for furans and dioxins in emissions and to the adoption of alternative disposal technologies such as inerting (mixing drugs, including their packaging, with liquid concrete) and encapsulation (mixing in agglomerated cement) and the subsequent disposal of that waste in large, very often unregulated, landfills.

In other countries, the adoption of the Convention has resulted in a drive towards incineration in large-scale plants that are capable of recovering energy and ensuring maximum environmental performance through costly gas emission abatement systems, although this does not eliminate the problem of daily waste handling.

The solutions described above concern only the treatment of solid waste posing a risk of infection and do not take into account waste from expired pharmaceuticals and cytotoxic residues.

Pharmaceutical and cytotoxic waste, if not properly managed, is highly hazardous to health and the environment.

In some countries, the disposal options for these types of waste are as follows:
1) Return of expired pharmaceutical and cytotoxic waste to the original supplier, including both expired but safely packaged pharmaceuticals and pharmaceuticals that are no longer needed. This option is complicated and involves the handling of waste.
2) Incineration at high temperatures using large, new-generation incinerators designed to completely destroy all substances contained in expired pharmaceutical and cytotoxic waste by reaching very high temperatures (1200° C.). Conversely, an incineration process at lower temperatures could result in hazardous cytotoxic vapours being released into the atmosphere.
3) Incineration in rotary kilns designed to perform the thermal decomposition of chemical waste in foundries or cement kilns operating at temperatures above 850° C. While this disposal option is technologically feasible, it requires authorisation from the competent authorities for the treatment of this particular category of waste.

In countries where the incineration of pharmaceutical and cytotoxic waste in small-to-medium sized incinerators is strongly discouraged, the following disposal options are adopted:
1) Inerting and Encapsulation: expired pharmaceutical and cytotoxic waste is encapsulated within an inert matrix (e.g. liquid concrete), with this waste consequently disposed of in large, often unregulated, landfills;
2) Chemical degradation: hazardous waste is converted into a non-toxic compound through oxidation with potassium permanganate or sulphuric acid, denitration with hydrobromic acid, or reduction with nickel and aluminium. However, this disposal process is time-consuming and stocks of these chemicals must always be available and disposed of properly.
3) Chemical neutralization through oxidation with sodium hypochlorite.

Nevertheless, these solutions are not satisfactory as they involve the daily handling and management of waste, and do not eliminate the chemical risk related with the storage and release of the chemical compounds used for chemical degradation and neutralisation.

Indeed, these treatments carry the risk of releasing dioxins, furans and other toxic pollutants into the air and ash.

Furthermore, medicinal waste such as a pharmaceutical and cytotoxic waste cannot be howsoever recovered after treatment.

### DISCLOSURE OF THE INVENTION

The aim of the present invention is to produce a technology for the efficient treatment of medicinal waste.

A further purpose of the present invention is to recover medicinal waste and subsequently to transform the treated waste into a new product.

According to the present invention, a plant is provided with the features defined in claim 1.

According to another aspect of the present invention, a process for the treatment of medicinal waste comprises the features of claim 9.

### BRIEF DESCRIPTION OF THE DRAWINGS

Further advantages and features of the present invention will become more apparent from the detailed description below with reference to the accompanying drawings, which show a non-limiting embodiment, in which:

FIG. 1 schematically shows a front-view of the plant in a first embodiment of the present invention before treatment begins;

FIG. 2 shows the plant in FIG. 1 during treatment;

FIG. 3 schematically shows a front-view of the plant in a second embodiment of the present invention before treatment begins;

FIG. 4 shows a perspective view of the plant in FIG. 3 during treatment.

### PREFERRED EMBODIMENTS OF THE INVENTION

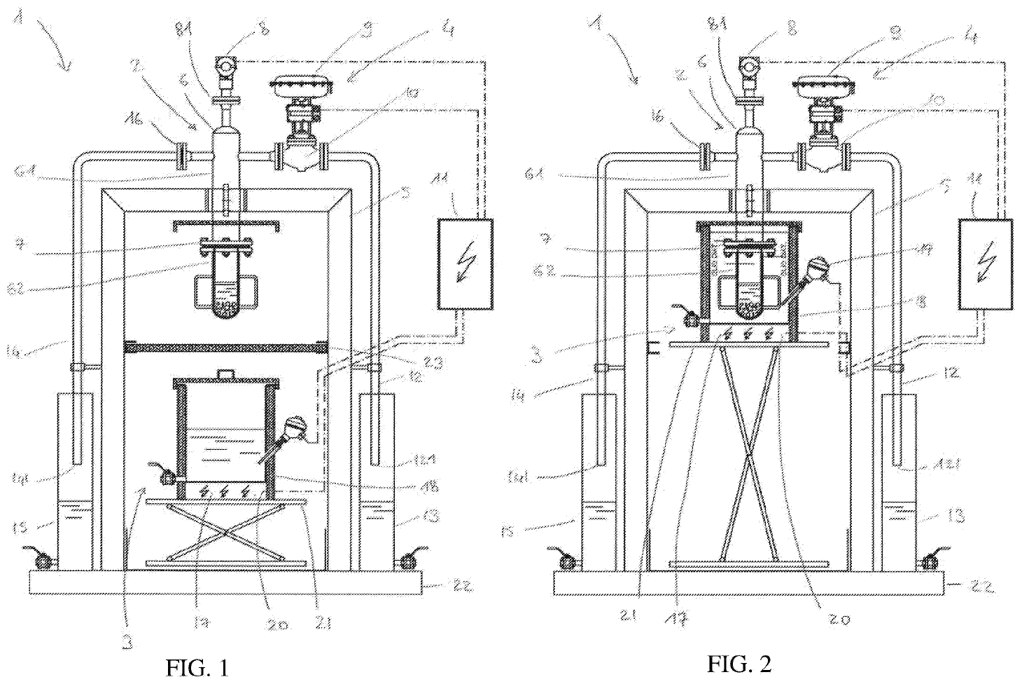

FIG. 1 shows, with reference number 1, a plant for the treatment of medicinal waste in a first embodiment of the present invention.

According to the invention, the plant 1 comprises at least one reaction cell 2 suitable for containing at least one liquid or liquid-diluted medicinal waste material; a heating system 3 suitable for uniformly heating at least one portion of the outer surface of the reaction cell 2; and a device 4 for controlling the pressure and temperature of the reaction cell 2, connected to the heating system 3.

The term “medicinal waste” means any type of medicinal substance that is no longer usable or is hazardous, including expired pharmaceuticals, cytotoxic products, vaccines, hyperimmune plasma, etc.

Heating takes place outside of the reaction cell. In particular, heating takes place outside of the external surface of the reaction cell 2.

Advantageously, heating takes place by immersing the reaction cell 2 at least partially in a heat transfer fluid. The heat transfer fluid is heated by transferring heat to the reaction cell 2 through the surface of the cell itself.

The figures show, by way of example, a vertically-developing plant.

The system 1 illustrated in the figures comprises a supporting structure 5 to which the reaction cell 2 is fixed.

The reaction cell 2 comprises a container 6 having at least one metal portion. Advantageously, the reaction cell 2 comprises at least two interconnectable metal portions. In the illustrated embodiment, the lower portion 61, into which the medicinal waste to be treated is inserted, and the upper portion 62 each have a flange 7. The flanges 7 are fixed together so as to close the container 6. The two portions 61, 62 of the container 6 are metallic. The upper portion 62 of the reaction cell 2 is fixed to the supporting structure 5.

The control device 4 advantageously comprises at least one pressure indicator 8 and at least one depressurisation system 9.

The depressurisation system 9 preferably comprises at least one automatic ventilation or depressurisation valve 10.

The pressure indicator 8 comprises at least one pressure sensor 81. In the illustrated embodiment, the pressure sensor 81 comprises a membrane separator positioned at the upper portion 62 of the reaction cell 2.

The control device 4 comprises a control panel 11 to which the depressurisation system 9 and the pressure indicator 8 are connected.

The plant 1 advantageously comprises at least one first discharge pipe 12 connected to the reaction cell 2. The free end 121 of the first pipe 12 is arranged in at least one first vessel 13 containing a liquid, such as water.

In a preferred embodiment, the upper portion 62 of the reaction cell 2 is connected to a first pipe 12 and a second discharge pipe 14.

In the embodiment illustrated in FIGS. 1 and 2, the free end 141 of the second pipe 14 is arranged in a second vessel 15 containing water.

The depressurisation system 9 is preferably arranged on the first pipe 12.

Advantageously, a safety system 16, for example comprising a rupture disk, is inserted on the second pipe 14.

The heating system 3 is arranged in the lower part of the supporting structure 5. In a preferred embodiment, the heating system 3 comprises at least one heating element 17, for example an electrical resistor, capable of heating a vessel 18 containing a heat transfer fluid, for example diathermic oil. A first temperature sensor 19 is arranged within the vessel 18. The first sensor 19 is connected to the control panel 11.

A second temperature sensor 20 is arranged at the heating element 17. The second sensor 20 is connected to the control panel 11.

A third temperature sensor (not shown) is arranged at the external surface of the reaction cell 2, in particular at the external surface of the lower portion 61. The third sensor is preferably connected to the control panel 11.

The heating system 3 is arranged on a vertically movable plane 21. In an advantageous embodiment, a safety containment tank 22 is arranged below the movable plane 21.

In the illustrated embodiment, a removable plane 23 is arranged between the heating system 3 and the reaction cell 2 to prevent the lower portion 61 of the reaction cell 2 from falling during opening. This removable plane 23 is advantageous in case of manual loading and removal of the contents of the reaction cell 2. Where these operations are automatic, the removable plane can be foregone.

In the illustrated embodiment, the reaction cell 2 and the heating system 3 are initially separated by the removable plane 23. The removable plane 23 is then removed and the heating system 3 is moved vertically towards the top of the supporting structure so that the reaction cell 2 is at least partially inserted into the fluid.

Once it reaches the metallic container 6 of the reaction cell 2, treatment begins.

The system 1 advantageously comprises an agitator 24 for moving the heat transfer fluid so as to increase the heat transfer, which thus occurs not only by conduction but also by convection.

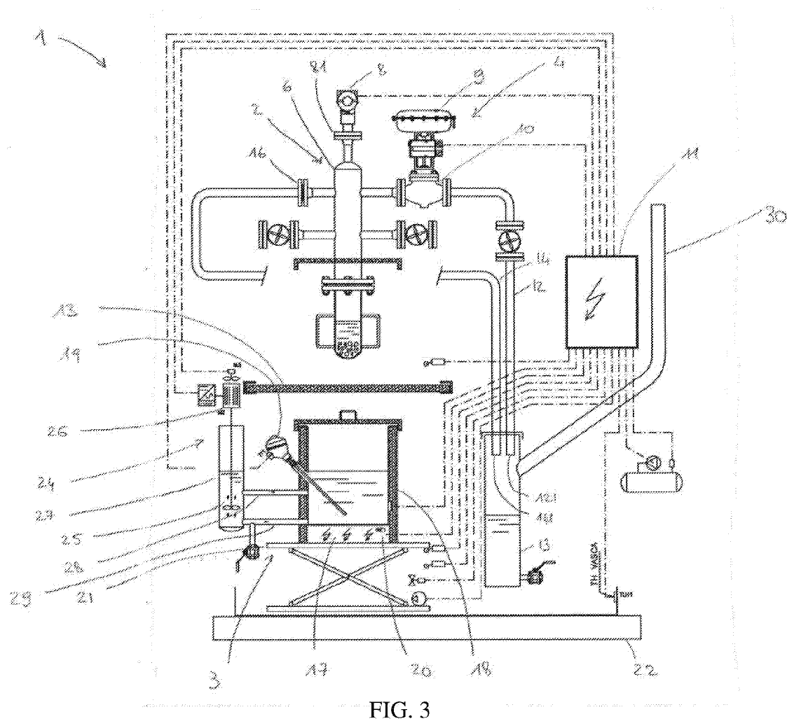

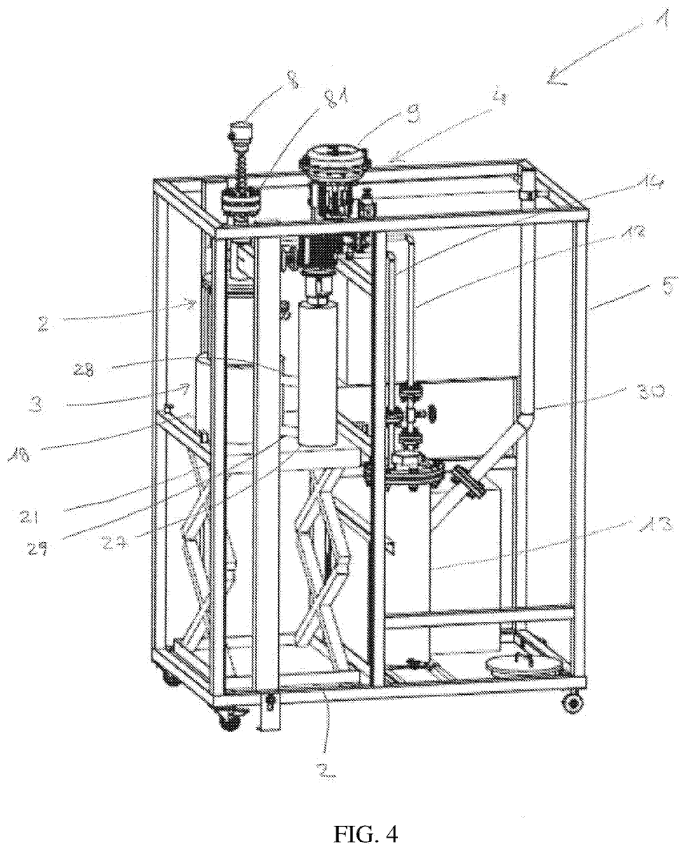

In the embodiment illustrated in FIGS. 3 and 4, the agitator 24 includes a helix associated with a respective motor 26. The helix 25 is arranged in a container 27 connected to the heat transfer fluid vessel 18 by an inlet pipe 28 and an outlet pipe 29.

In an alternative embodiment not shown, the agitator comprises a pump for circulating the heat transfer fluid.

In the embodiment in FIGS. 3 and 4, the free end 141 of the second pipe 14 is inserted in the first vessel 13 containing water. A conduit 30 is connected to the vessel 13 to convey ventilation vapours. The conduit may be provided with an active carbon filter.

In an alternative embodiment not shown, the plant develops horizontally. The vessel containing the heat transfer fluid is substantially closed and is externally associated with a heating element.

The vessel has an opening into which the reaction cell is inserted. The opening is closed by a lid during treatment. The lid is associated with at least one discharge pipe and the pressure indicator. The lid may have a transparent portion to check the progress of the process from the outside.

The process for the treatment of medicinal waste according to the invention comprises the steps of:
a) placing at least one medicinal waste material in a reaction cell;
b) for solid medicinal waste, adding a liquid to the reaction cell;
c) uniformly heating at least a portion of the reaction cell until a predetermined pressure value is reached inside the reaction cell;
d) maintaining a constant temperature value of the reaction cell for a predetermined time.

The treatment essentially comprises a hydrothermal carbonisation (HTC) process.

In a preferred embodiment, heating takes place outside of the external surface of the reaction cell 2.

Advantageously, heating is carried out indirectly using a heat transfer fluid, in particular diathermic oil.

In particular, the heat transfer fluid is arranged in a vessel and heated, for example by means of electrical resistors.

The process can be implemented using the plant described above. The plant treats medicinal waste essentially through a hydrothermal carbonisation (HTC) process.

In one embodiment of the process, the vessel 18 is initially placed apart from the reaction cell 2 to allow the medicinal waste to be easily inserted inside the reaction cell 2.

The vessel 18 is then lifted vertically so that the portion of the reaction cell 2 in which the medicinal waste is arranged is immersed in the diathermic oil.

From the control panel 11, the heating of the diathermic oil is activated by means of the heating elements.

To increase the transfer of heat from the diathermic oil to the reaction cell 2, the agitator 24 may be activated.

The oil is heated to a temperature of between around 200° C. and around 300° C., preferably around 250° C., resulting in an increase in temperature and pressure in the reaction cell 2.

The pressure in the reaction cell 2 stabilises when the treatment temperature is reached. This treatment temperature is kept constant for a predetermined period. The maximum operating temperature of the reaction cell is between around 200° C. and around 250° C.

In particular, the temperature of the reaction cell 2 is measured indirectly by measuring the pressure inside the reaction cell using the pressure sensor 81.

The third temperature sensor placed on the external surface of the reaction cell 2 forms an independent control of the estimated temperature.

The maximum operating pressure of the reaction cell is between around 20 bar and around 30 bar.

In the event that high pressures build up inside the reaction cell (above 30 bar), it is possible to discharge the gases contained therein through the depressurisation valve.

At the end of the treatment cycle, the heating system is lowered and the heat transfer fluid vessel is covered with a lid. The treated medicinal waste can be extracted only after reaching ambient pressure. Finally, at the end of the treatment cycle, the reaction cell can be treated with inert gas.

The treatment essentially comprises a hydrothermal carbonisation (HTC) process.

This process is a thermochemical process normally used for the conversion of biomass at relatively low temperature and pressure conditions in the presence of liquid water (pressures of up to around 40 bar and temperatures of up to around 250° C.). During the HTC reaction, water, carbon dioxide and other compounds are separated from the biomass to generate—within a timescale of more than 8 hours—a carbonaceous solid, the biocarbon or hydrochar (hereinafter HC). The HTC process simulates the conditions which, in nature, turned plant material into peat or lignite. The starting material for this transformation is usually plant and biological waste from agricultural, industrial and commercial activities, as well as waste from sorted urban waste collection.

According to the present invention, the hydrothermal carbonisation process is applied to medicinal waste, from which hydrochar is the product. The medicinal product is removed from the packaging. If the medicinal product is in a solid state, water is preferably added as a diluent and oxidant to the reaction cell.

In this specific case, the hydrochar obtained at the end of the process is that which is most suitable for agricultural purposes. In particular, an organic soil conditioner usable for optimising soil fertility and water retention in cultivated land is obtained.

The process provides for a phase of depressurising the reaction cell at the end of the treatment. The depressurisation of the reaction cell is followed by a phase of removing the treated product.

The plant advantageously includes an air treatment unit to be activated if harmful gases are generated during the depressurisation of the reaction cell.

In a preferred embodiment, the plant includes a recirculation system for reprocessing the water resulting from a first treatment of the pharmaceutical. The recirculation system is activated if unreacted substances, such as furans and thiols, are detected in the water.

Advantageously, the process includes the performance of analyses of the product taken from the reaction cell to verify the absence of active ingredients.

Analyses include:
1. “FT-IR” spectroscopy: this enables the follow-up of the degradation kinetics and the progressive transformation of organic into inorganic carbon both on the liquid and on the solid part; and/or
2. Thermo-gravimetric analysis (TGA): for a quantitative analysis of the HC produced, in order to verify the percentage conversion of organic carbon into inorganic carbon; and/or
3. Total Organic Carbon (TOC): for a quantitative analysis of the fraction of organic carbon out of the total carbon present in the HC produced.

If the active ingredient is still present, a new cycle is carried out until the treatment performance improves.

Advantageously, the process requires analyses to be carried out to check for harmful airborne emissions and pollutants in the treatment water.

Analyses include:
1. Gas chromatography-mass spectrometry (GC-MS): to assess the likely presence of Furans/Tiols or other macromolecules or unreacted active ingredients; and/or
2. Determination of PAHs: evaluation of polycyclic aromatic hydrocarbons produced during the hydrothermal carbonisation process that have carcinogenic/mutagenic activity, causing skin or lung cancer; and/or
3. Determination of PCBs: evaluation of polychlorinated biphenyls, a group of chemical compounds that are difficult to biodegrade and accumulate in the fatty tissues of living organisms, and are therefore considered toxic.

The process and the plant according to the present invention thus enable the on-site treatment of medicinal waste, such as pharmaceutical or cytotoxic waste, vaccines, hyperimmune plasma, etc., by eliminating the risks associated with their handling and final disposal.

In addition, the process according to the present invention enables pharmaceutical waste to be transformed into hydrochar. Therefore, pharmaceutical waste becomes “zero waste”; i.e. it can play a useful role again in terms of the circular economy.

1. A plant for the treatment of medicinal waste comprising at least one reaction cell suitable for containing at least one liquid or liquid-diluted medicinal waste material; a heating system suitable for uniformly heating at least one portion of the outer surface of the reaction cell; and a device for controlling the pressure and temperature of the reaction cell, connected to the heating system.

2. The plant according to claim 1, wherein the heating system comprises a vessel containing a heat exchange fluid, in particular diathermic oil, which, in use, at least partially surrounds the reaction cell, the vessel being associable with a heating element.

3. The plant according to claim 2, characterised by comprising at least one heat exchange fluid temperature sensor connected to the control device.

4. The plant according to claim 2, characterised by comprising an agitator for moving the fluid during heating.

5. The plant according to claim 1, wherein the reaction cell comprises a container having at least one metal portion.

6. The plant according to claim 1, wherein the reaction cell comprises at least two interconnectable metal portions.

7. The plant according to claim 1, characterised by comprising at least one discharge pipe connected to the reaction cell.

8. The plant according to claim 7, wherein the discharge pipe is associated with the control device.

9. A process for the treatment of medicinal waste, comprising the steps of:
a) placing at least one medicinal waste material in a reaction cell;
b) for solid medicinal waste, adding a liquid to the reaction cell;
c) uniformly heating at least a portion of the reaction cell until a predetermined pressure value is reached inside the reaction cell;
d) maintaining a constant temperature value of the reaction cell for a predetermined time.

10. The process according to claim 9, characterised by comprising a step of heating a heat exchange fluid, in particular diathermic oil.

11. The process according to claim 10, characterised by placing at least one portion of the reaction cell in the heat exchange fluid.

12. The process according to claim 9, characterised by including a step of depressurising the reaction cell if the pressure inside the reaction cell exceeds a predetermined value.

13. The process according to claim 9, characterised by conveying the gases present inside the reaction cell into at least one container containing a liquid, in particular water, in the depressurisation phase.

14. Process according to claim 9, characterised by uniformly heating at least a portion of the reaction cell until a substantially constant pressure value is reached inside the reaction cell.

15. The process according to claim 9, characterised by maintaining the reaction cell at the temperature reached at the moment when the pressure is substantially constant.
